(19) United States
(12) Patent Application Publication
(10) Pub. No.: US 2010/0089419 A1
(43) Pub. Date: Apr. 15, 2010

(54) ELECTROCHEMICALLY-ACTIVATED LIQUID FOR COSMETIC REMOVAL

(75) Inventors: Bruce F. Field, Golden Valley, MN (US); Todd R. Schaeffer, St. Michael, MN (US)

Correspondence Address: WESTMAN CHAMPLIN & KELLY, P.A., SUITE 1400, 900 SECOND AVENUE SOUTH, MINNEAPOLIS, MN, 55402, US

(73) Assignee: TENNANT COMPANY, Minneapolis, MN (US)

(21) Appl. No.: 12/552,508

(22) Filed: Sep. 2, 2009

Related U.S. Application Data
(60) Provisional application No. 61/093,639, filed on Sep. 2, 2008.

(51) Int. Cl. B08B 7/00

(52) U.S. Cl. 134/6

(57) ABSTRACT

A method for removing a cosmetic substance, the method comprising electrochemically activating a liquid, dispensing the electrochemically-activated liquid to a surface containing the cosmetic substance, and applying frictional wiping to the surface containing the cosmetic substance and the applied electrochemically-activated liquid.

### CROSS-REFERENCE TO RELATED APPLICATION(S)

The present application claims priority to U.S. Provisional Patent Application No. 61/093,639, filed on Sep. 2, 2008, and entitled “Electrochemically-Activated Liquid For Cosmetic Removal”, the disclosure of which is incorporated by reference in its entirety.

Reference is also hereby made to U.S. patent application Ser. No. 11/655,365, entitled “Cleaning Apparatus Having A Functional Generator For Producing Electrochemically Activated Cleaning Liquid”, and published as U.S. Publication No. 2007/0186368 on Aug. 16, 2007; U.S. patent application Ser. No. 12/488,301, entitled “Electrolysis Cell Having Conductive Polymer Electrodes And Method Of Electrolysis”; U.S. patent application Ser. No. 12/488,613, entitled “Hand-Held Spray Bottle Electrolysis Cell And DC-DC Converter”; U.S. patent application Ser. No. 12/488,333, entitled “Electrolysis Cell Having Electrodes With Various-Sized/Shaped Apertures”; U.S. patent application Ser. No. 12/488,360, entitled “Tubular Electrolysis Cell And Corresponding Method”; and U.S. patent application Ser. No. 12/488,368, entitled “Apparatus Having Electrolysis Cell And Indicator Light Illuminating Through Liquid”, each of which is commonly assigned to the present assignee.

### FIELD OF THE DISCLOSURE

The present disclosure relates to methods of cosmetic removal. In particular, the present disclosure relates to the use of electrochemically-activated liquids for the removal of cosmetic substances.

### BACKGROUND

Cosmetics substances are typically used to enhance the appearance of the human body, such as facial features. For example, mascaras may be used on the eyelashes, eyeliners in liquid or solid form may be used to outline the eyelids near the eyelashes, and other substances, such as eye shadows, foundation creams, face powders, rouge, and lipsticks may be used in similar manners. Such substances are primarily used by modern women to enhance and color various facial features. In addition, cosmetic substances are used in theatrics and costume designs, and may also be used to provide protective care (e.g., sun screen and moisturizing lotions).

After use, most people desire to fully remove the applied cosmetic substances, thereby leaving the facial and neck regions clean. A variety of cosmetic removal preparations are commercially available, such as water-based liquids, oil-based liquids, and creams. However, many of the liquid-based preparations may irritate the skin. Furthermore, such liquids are typically non-viscous, and may flow into the eyes and mouth regions, thereby increasing the risk of causing irritating contact with these regions. Cosmetic removal creams, on the other hand, are typically messy and are difficult to use around the eye regions. Thus, there is an ongoing need for additional cosmetic removal techniques that are easy to use and do not cause irritations to facial regions.

### SUMMARY

An aspect of the disclosure is directed to a method for removing a cosmetic substance. The method includes electrochemically activating a liquid, dispensing the electrochemically-activated liquid to a surface containing the cosmetic substance, and applying frictional wiping to the surface containing the cosmetic substance and the applied electrochemically-activated liquid.

Another aspect of the disclosure is directed to a method for removing a cosmetic substance, which includes directing a liquid through an electrolysis cell carried by a dispenser to produce an anolyte liquid and a catholyte liquid in the electrolysis cell, and combining a flow of the anolyte liquid with a flow of the catholyte liquid to form a blended anolyte and catholyte liquid. The method further includes dispensing the blended anolyte and catholyte liquid from the dispenser, and applying frictional wiping to a surface containing the cosmetic substance using the electrochemically-activated liquid.

A further aspect of the disclosure is directed to a method for removing a cosmetic substance, which includes introducing a first part of a liquid into a first electrolysis chamber comprising a first electrode, and introducing a second part of the liquid into a second electrolysis chamber comprising a second electrode, where the second electrolysis chamber is separated from the first electrolysis chamber by an ion exchange membrane. The method further includes applying a voltage across the first and second electrodes to electrochemically activate the first and second parts of the liquid, dispensing the electrochemically-activated first and second parts of the liquid as a blended output spray from the spray bottle, and applying frictional wiping to a surface containing the cosmetic substance with the use of the dispensed electrochemically-activated, blended output spray.

A further aspect of the disclosure is directed to a method for removing a cosmetic substance, which includes directing a liquid through an electrolysis cell carried by a dispenser to produce an anolyte liquid and a catholyte liquid in the electrolysis cell, dispensing the anolyte liquid from a first nozzle onto a surface, and dispensing the catholyte liquid from a second nozzle onto the surface. The method further includes applying frictional wiping to the cosmetic substance using the dispensed anolyte liquid and the dispensed catholyte liquid.

### BRIEF DESCRIPTION OF THE DRAWINGS

FIG. 1 schematic illustration of a spray-bottle for electrochemically activating and dispensing a liquid onto a surface containing a cosmetic substance.

FIG. 2 is a schematic illustration of an electrolysis cell of the production system, where the electrolysis cell has a dual-chamber arrangement with an ion-exchange membrane.

FIG. 3 is a schematic illustration of an alternative electrolysis cell of the production system, where the alternative electrolysis cell includes a single-chamber arrangement without an ion-exchange membrane.

FIG. 4 is a schematic illustration of an example of an electrolysis cell having a tubular shape.

FIG. 5 is a flow diagram of a method for removing a cosmetic substance with an electrochemically-activated liquid.

### DETAILED DESCRIPTION

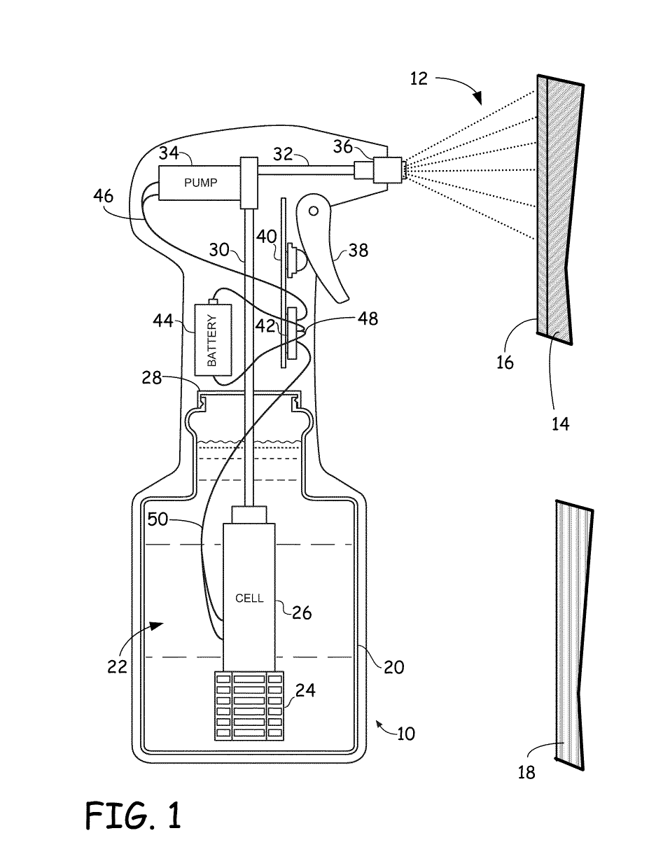

FIG. 1 illustrates spray bottle 10 dispensing streams 12 of an electrochemically-activated (EA) liquid onto 14 surface, where surface 14 is a suitable surface (e.g., epidermal skin of a user's facial or neck region) that contains film 16 of one or more cosmetic substances. Spray bottle 10 is an exemplary hand-held spray bottle configured to electrochemically activate a liquid, and to dispense the EA liquid onto one or more surfaces. In the embodiment shown in FIG. 1, the EA liquid is dispensed directly onto the surface of a user's skin containing the cosmetic substance (e.g., surface 14). Alternatively, the EA liquid may be dispensed onto an intermediary wipe 18, and wipe 18 may then be used to remove film 16 from surface 14 with the use of the dispensed EA liquid. As discussed below, the EA liquid is beneficial for reducing the amount of frictional wiping required to remove cosmetic substances from a surface, and reduces the risk of irritating a user's skin, eyes, nasal passages, and/or mouth.

Spray bottle 10 includes housing 20, which desirably defines reservoir 22 for retaining a liquid to be treated and then dispensed. In one embodiment, the liquid to be treated includes an aqueous composition, such as regular tap water. Spray bottle 10 further includes inlet filter 24, one or more electrolysis cells 26, housing cap 28, fluid conduits 30 and 32, pump 34, nozzle 36, actuator 38, switch 40, control electronics 42, and batteries 44. Although not shown in FIG. 1, fluid conduits 30 and 32 may be housed within a neck and barrel of spray bottle 10, respectively. In one embodiment, cap 28 may form a seal with the neck portion of spray bottle 10, thereby securing the neck portion to housing 20.

Examples of suitable designs for spray bottle 10 include those disclosed in U.S. patent application Ser. No. 12/488,301, entitled “Electrolysis Cell Having Conductive Polymer Electrodes And Method Of Electrolysis”; U.S. patent application Ser. No. 12/488,613, entitled “Hand-Held Spray Bottle Electrolysis Cell And DC-DC Converter”; U.S. patent application Ser. No. 12/488,333, entitled “Electrolysis Cell Having Electrodes With Various-Sized/Shaped Apertures”; U.S. patent application Ser. No. 12/488,360, entitled “Tubular Electrolysis Cell And Corresponding Method”; and U.S. patent application Ser. No. 12/488,368, entitled “Apparatus Having Electrolysis Cell And Indicator Light Illuminating Through Liquid”.

Pump 34 is desirably an electrically-powered pump that receives electrical power from switch 42 via one or more power lines 46. In alternative embodiments, pump 34 may be located at different locations downstream of electrolysis cell 26 (as shown in FIG. 1), or upstream of electrolysis cell 26 with respect to the direction of liquid flow from reservoir 22 to nozzle 36. Additionally, pump 34 may function as a mechanical pump, such as a hand-triggered positive displacement pump, where actuator trigger 38 may act directly on the pump by mechanical action. In this embodiment, switch 40 may be separately actuated from the pump 34, such as a power switch, to energize electrolysis cell 26.

Nozzle 36 is a dispensing nozzle for dispensing streams 12 of the EA liquid. In various embodiments, nozzle 36 may have different settings (or may be adjustable to multiple settings), thereby allowing stream 12 to have different dispensing states (e.g., squirting a stream, aerosolizing a mist, and dispensing a spray). Actuator 38 is a trigger-style actuator, which actuates switch 40 between open and closed states. In alternative embodiments, actuator 38 may exhibit other styles and operations, or may be omitted in further embodiments. In embodiments that lack a separate actuator, switch 40 can be actuated directly by a user. Switch 40 may operate with a variety of different actuator designs. Examples of suitable actuator designs include push-button switches (e.g., as shown in FIG. 1), toggles, rockers, mechanical linkages, non-mechanical sensors (e.g., capacitive, resistive plastic, thermal, and inductive sensors), and combinations thereof. Switch 40 can also have a variety of different contact arrangements, such as momentary, single-pole, single throw, and the like.

Batteries 44 include one or more disposable batteries and/or rechargeable batteries, and provide electrical power to electrolysis cell 26 and pump 34 when energized by control electronics 42, as discussed below. In the shown embodiment, batteries 44 supply power to control electronics 42 via one or more power lines 48, and control electronics 42 provide electrical power to pump 34 via power line 46 (as discussed above) and to electrolysis cell 26 via one or more power lines 50. Examples of suitable batteries and control electronics for batteries 44 and control electronics 42 include those disclosed in the above-discussed patent applications for the suitable designs for spray bottle 10.

When switch 40 is in the open, non-conducting state, control electronics 42 de-energizes electrolysis cell 26 and pump 34. This prevents pump 34 from pumping liquid through spray bottle 10, and prevents electrolysis cell 26 from electrochemically activating the liquid. Alternatively, when a user engages actuator 38, the motion of actuator 38 closes switch 40 to a closed, conducting state, thereby allowing control electronics 42 to energize electrolysis cell 26 and pump 34. Pump 34 then draws liquid from reservoir 22 through filter 24, electrolysis cell 26, and fluid conduit 30, and forces the resulting EA liquid out of fluid conduit 32 and nozzle 36 as stream 12. Stream 12 then contacts film 16 cosmetic substance and/or surface 14, thereby allowing the EA liquid to chemically affect the cosmetic substance of film 16. When a user subsequently provides frictional wiping to the EA liquid and film 16 (e.g., with wipe 18), the cosmetic substance is readily removed without requiring excessive frictional force. This increases the ease of removing film 16 after use.

As discussed below, spray bottle 10 may contain a liquid to be dispensed on a surface (e.g., surface 14) to assist in the removal of cosmetic substances. In one embodiment, electrolysis cell 26 converts the liquid from reservoir 22 into an anolyte EA liquid and a catholyte EA liquid prior to being dispensed from spray bottle 10. The anolyte and catholyte EA liquids can be dispensed as a combined mixture or as separate spray outputs, such as through separate tubes and/or nozzles (e.g., nozzle 36). In the embodiment shown in FIG. 1, the anolyte and catholyte EA liquids are dispensed as a combined mixture. With a small and intermittent output flow rate provided by spray bottle 10, electrolysis cell 26 can have a small package and be powered by batteries 44.

Electrolysis cell 26 is a fluid treatment cell that is adapted to apply an electric field across the liquid between at least one anode electrode and at least one cathode electrode. Suitable cells for electrolysis cell 26 may have any suitable number of electrodes, and any suitable number of chambers for containing the water. As discussed below, electrolysis cell 26 may include one or more ion exchange membranes between the anode and cathode, or can be configured without ion exchange membranes. Electrolysis cell 26 may have a variety of different structures, such as, but not limited to those disclosed in Field et al., U.S. Patent Publication No. 2007/0186368, published Aug. 16, 2007. In an alternative embodiment, spray bottle 10 may include multiple electrolysis cells 26 that operate in series and/or parallel arrangements to electrochemically activate the liquid. In additional alternative embodiments, the liquid may be electrochemically activated from one or more external sources (e.g., one or more external electrolysis cells).

The liquid is supplied to electrolysis cell 26 through filter 24, which correspondingly receives the liquid from reservoir 22. In one embodiment, the liquid may flow through electrolytic cell 26 as separate streams. Alternatively, the liquid may be separated after entering electrolytic cell 26. As the liquid flows through electrolytic cell 26, the electric field applied across the liquid in electrolysis cell 26 electrochemically activates the liquid, which separates the liquid by collecting positive ions (i.e., cations, H⁺) on one side of an electric circuit and collecting negative ions (i.e., anions, OH⁻) on the opposing side. The liquid having the cations is thereby rendered acidic and the liquid having the anions is correspondingly rendered alkaline.

The electrolysis process may also generate gas-phase bubbles, where the sizes of the gas-phase bubbles may vary depending on a variety of factors, such as the pressure through electrolysis cell 26 and the extent of the electrochemical activation. Accordingly, the gas-phase bubbles may have a variety of different sizes, including, but not limited to macrobubbles, microbubbles, nanobubbles, and mixtures thereof. In embodiments including macrobubbles, examples of suitable average bubble diameters for the generated bubbles include diameters ranging from about 500 micrometers to about one millimeter. In embodiments including microbubbles, examples of suitable average bubble diameters for the generated bubbles include diameters ranging from about one micrometer to less than about 500 micrometers. In embodiments including nanobubbles, examples of suitable average bubble diameters for the generated bubbles include diameters less than about one micrometer, with particularly suitable average bubble diameters including diameters less than about 500 nanometers, and with even more particularly suitable average bubble diameters including diameters less than about 100 nanometers.

The electrolysis process may also restructure the liquid by breaking the liquid into smaller units that can penetrate cells much more efficiently than a normal liquid. For example, most tap water and bottled water are made of large conglomerates of unstructured water molecules that are too large to move efficiently into cells. The EA liquid, however, is a structured liquid that penetrates the cells at a much faster rate for better nutrient absorption and more efficient waste removal. Smaller liquid units also have a positive effect on the efficiency of metabolic processes.

The resulting streams of the EA liquid may exit electrolysis cell 26 and recombined in fluid conduit 30. Alternatively, the liquid stream rendered acidic and the liquid stream rendered alkaline may be recombined prior to exiting electrolysis cell 26, and the combined stream may through fluid conduit 30 as the desired liquid product stream. As discussed below, despite being recombined, the acidic water and the alkaline water retain their ionic properties and gas-phase bubbles for a sufficient duration to allow the liquid to be dispensed onto surface 14 containing the cosmetic substance.

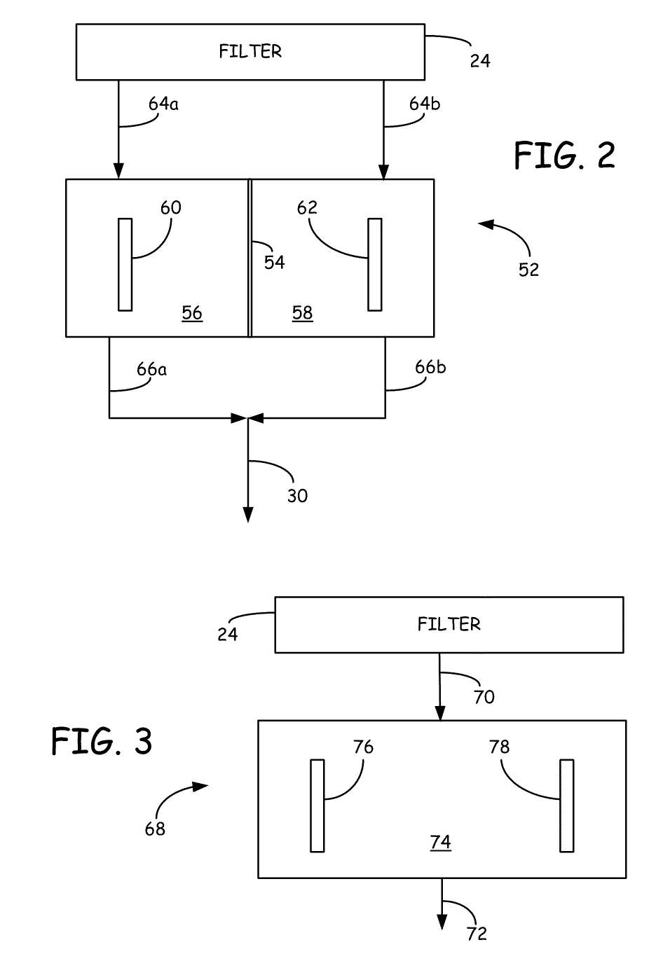

FIG. 2 is a schematic illustration of electrolysis cell 52, which is an exemplary design for electrolysis cell 26 (shown in FIG. 1). As shown in FIG. 2, electrolysis cell 52 includes membrane 54, which separates electrolysis cell 52 into anode chamber 56 and cathode chamber 58. While electrolysis cell 52 is illustrated in FIG. 3 as having a single anode chamber and a single cathode chamber, electrolysis cell 52 may alternatively include a plurality of anode and cathode chambers separated by one or more membranes 54.

Membrane 54 is an ion exchange membrane, such as a cation exchange membrane (i.e., a proton exchange membrane) or an anion exchange membrane. Suitable cation exchange membranes for membrane 54 include partially and fully fluorinated ionomers, polyaromatic ionomers, and combinations thereof. Examples of suitable commercially available ionomers for membrane 54 include sulfonated tetrafluorethylene copolymers available under the trademark “NAFION” from E.I. du Pont de Nemours and Company, Wilmington, Del.; perfluorinated carboxylic acid ionomers available under the trademark “FLEMION” from Asahi Glass Co., Ltd., Japan; perfluorinated sulfonic acid ionomers available under the trademark “ACIPLEX” Aciplex from Asahi Chemical Industries Co. Ltd., Japan; and combinations thereof.

Anode chamber 56 and cathode chamber 58 respectively include anode electrode 60 and cathode electrode 62, where membrane 54 is disposed between anode electrode 60 and cathode electrode 62. Anode electrode 60 and cathode electrode 62 can be made from any suitable electrically-conductive material, such as titanium, and may be coated with one or more precious metals (e.g., platinum). Anode electrode 60 and cathode electrode 62 may each also exhibit a variety of different geometric designs and constructions, such as flat plates, coaxial plates (e.g., for tubular electrolytic cells), rods, and combinations thereof; and may have solid constructions or can have one or more apertures (e.g., metallic meshes). While anode chamber 56 and cathode chamber 58 are each illustrated with a single anode electrode 60 and cathode electrode 62, anode chamber 56 may include a plurality of anode electrodes 60, and cathode chamber 58 may include a plurality of cathode electrodes 62.

Anode electrode 60 and cathode electrode 62 may be electrically connected to opposing terminals of a conventional power supply (e.g., batteries 44). The power supply can provide electrolysis cell 52 with a constant direct-current (DC) output voltage, a pulsed or otherwise modulated DC output voltage, or a pulsed or otherwise modulated AC output voltage, to anode electrode 60 and cathode electrode 62. The power supply can have any suitable output voltage level, current level, duty cycle, or waveform. In one embodiment, the power supply applies the voltage supplied to anode electrode 60 and cathode electrode 62 at a relative steady state. The power supply includes a DC/DC converter that uses a pulse-width modulation (PWM) control scheme to control voltage and current output. Other types of power supplies can also be used, which can be pulsed or not pulsed, and at other voltage and power ranges. The parameters are application-specific. The polarities of anode electrode 60 and cathode electrode 62 may also be flipped during operation to remove any scales that potentially form on anode electrode 60 and cathode electrode 62.

During operation, the liquid is supplied to electrolysis cell 52 from reservoir 22, and are desirably separated into fluid inlets 64a and 64b after passing through filter 24. The liquid flowing through fluid inlet 64a flows into anode chamber 56, and the liquid flowing through feed inlet 64b flows into cathode chamber 58. A voltage potential is applied to electrochemically activate the liquid flowing through anode chamber 56 and cathode chamber 58. For example, in an embodiment in which membrane 54 is a cation exchange membrane, a suitable voltage (e.g., a DC voltage) potential is applied across anode electrode 60 and cathode electrode 62. The actual potential required at any position within electrolytic cell 52 may be determined by the local composition of the liquid. In addition, a greater potential difference (i.e., over potential) is desirably applied across anode electrode 60 and cathode electrode 62 to deliver a significant reaction rate. Platinum-based electrodes typically require an addition of about one-half of a volt to the potential difference between the electrodes. In addition, a further potential is desirable to drive the current through electrolytic cell 52.

Upon application of the voltage potential across anode electrode 60 and cathode electrode 62, cations (e.g., H⁺) generated in the liquid of anode chamber 56 transfer across membrane 54 towards cathode electrode 58, while anions (e.g., OH⁻) generated in the liquid of anode chamber 56 move towards anode electrode 60. Similarly, cations (e.g., H⁺) generated in the liquid of cathode chamber 58 also move towards cathode electrode 62, and anions (e.g., OH⁻) generated in the liquid of cathode chamber 58 attempt to move towards anode electrode 60. However, membrane 54 prevents the transfer of the anions present in cathode chamber 58. Therefore, the anions remain confined within cathode chamber 58.

While the electrolysis continues, the anions in the liquid bind to the metal atoms (e.g., platinum atoms) at anode electrode 60, and the cations in the liquid (e.g., hydrogen) bind to the metal atoms (e.g., platinum atoms) at cathode electrode 62. These bound atoms diffuse around in two dimensions on the surfaces of the respective electrodes until they take part in further reactions. Other atoms and polyatomic groups may also bind similarly to the surfaces of anode electrode 60 and cathode electrode 62, and may also subsequently undergo reactions. Molecules such as oxygen (O₂) and hydrogen (H₂) produced at the surfaces may enter small cavities in the liquid phase of the liquid (i.e., bubbles) as gases and/or may become solvated by the liquid phase.

Surface tension at a gas-liquid interface is produced by the attraction between the molecules being directed away from the surfaces of anode electrode 60 and cathode electrode 62 as the surface molecules are more attracted to the molecules within the liquid than they are to molecules of the gas at the electrode surfaces. In contrast, molecules of the bulk of the liquid are equally attracted in all directions. Thus, in order to increase the possible interaction energy, surface tension causes the molecules at the electrode surfaces to enter the bulk of the liquid.

In the embodiments in which gas-phase nanobubbles are generated, the gas contained in the nanobubbles (i.e., bubbles having diameters of less than about one micrometer) are also believed to be stable for substantial durations in the liquid phase, despite their small diameters. While not wishing to be bound by theory, it is believed that the surface tension of the liquid, at the gas/liquid interface, drops when curved surfaces of the gas bubbles approach molecular dimensions. This reduces the natural tendency of the nanobubbles to dissipate.

Furthermore, nanobubble gas/liquid interface is charged due to the voltage potential applied across membrane 54. The charge introduces an opposing force to the surface tension, which also slows or prevents the dissipation of the nanobubbles. The presence of like charges at the interface reduces the apparent surface tension, with charge repulsion acting in the opposite direction to surface minimization due to surface tension. Any effect may be increased by the presence of additional charged materials that favor the gas/liquid interface.

The natural state of the gas/liquid interfaces appears to be negative. Other ions with low surface charge density and/or high polarizability (such as Cl⁻, ClO⁻, HO₂⁻, and O₂⁻) also favor the gas/liquid interfaces, as do hydrated electrons. Aqueous radicals also prefer to reside at such interfaces. Thus, it is believed that the nanobubbles present in the catholyte (i.e., the sub-stream flowing through cathode chamber 58) are negatively charged, but those in the anolyte (i.e., the sub-stream flowing through anode chamber 56) will possess little charge (the excess cations cancelling out the natural negative charge). Accordingly, catholyte nanobubbles are not likely to lose their charge on mixing with the anolyte sub-stream at the subsequent convergence point, and are otherwise stable for a duration that is greater than the residence time of the resulting EA liquid within spray bottle 10.

Additionally, gas molecules may become charged within the nanobubbles (such as O₂⁻), due to the excess potential on the cathode, thereby increasing the overall charge of the nanobubbles. The surface tension at the gas/liquid interface of charged nanobubbles can be reduced relative to uncharged nanobubbles, and their sizes stabilized. This can be qualitatively appreciated as surface tension causes surfaces to be minimized, whereas charged surfaces tend to expand to minimize repulsions between similar charges. Raised temperature at the electrode surface, due to the excess power loss over that required for the electrolysis, may also increase nanobubble formation by reducing local gas solubility.

As the repulsion force between like charges increases inversely as the square of their distances apart, there is an increasing outwards pressure as a bubble diameter decreases. The effect of the charges is to reduce the effect of the surface tension, and the surface tension tends to reduce the surface whereas the surface charge tends to expand it. Thus, equilibrium is reached when these opposing forces are equal. For example, assuming the surface charge density on the inner surface of a gas bubble (radius r) is Φ(e⁻/meter²), the outwards pressure (“Pₒᵤₜ”), can be found by solving the NavierStokes equations to give:

Pₒᵤₜ=Φ²/2Dε₀ (Equation 1)

where D is the relative dielectric constant of the gas bubble (assumed unity), “ε₀” is the permittivity of a vacuum (i.e., 8.854 pF/meter). The inwards pressure (“Pᵢₙ”) due to the surface tension on the gas is:

Pᵢₙ=2 g/r Pₒᵤₜ (Equation 2)

where “g” is the surface tension (0.07198 Joules/meter² at 25° C.). Therefore if these pressures are equal, the radius of the gas bubble is:

r=0.28792 ε₀/Φ². (Equation 3)

Accordingly, for nanobubble diameters of 5 nanometers, 10 nanometers, 20 nanometers, 50 nanometers, and 100 nanometers the calculated charge density for zero excess internal pressure is 0.20, 0.14, 0.10, 0.06 and 0.04 e⁻/nanometer² bubble surface area, respectively. Such charge densities are readily achievable with the use of electrolysis cell 24. The nanobubble radius increases as the total charge on the bubble increases to the power ⅔. Under these circumstances at equilibrium, the effective surface tension of the liquid at the nanobubble surface is zero, and the presence of charged gas in the bubble increases the size of the stable nanobubble. Further reduction in the bubble size would not be indicated as it would cause the reduction of the internal pressure to fall below atmospheric pressure.

In various situations within electrolysis cell 158, the nanobubbles may divide into even smaller bubbles due to the surface charges. For example, assuming that a bubble of radius “r” and total charge “q” divides into two bubbles of shared volume and charge (radius r½=r/2^{1/3}, and charge q_{1/2}=q/2), and ignoring the Coulomb interaction between the bubbles, calculation of the change in energy due to surface tension (ΔE_{ST}) and surface charge (ΔE_{q}) gives:

ΔE_{ST}=+2(4πγr_{1/2}²)−4πγr²=4πγr²(2^{1/3}−1) (Equation 3)

and

$$\begin{matrix}Δ {E}_{q} = - 2 ( 1 / 2 \times \frac{{( q / 2 )}^{2}}{4 π {ɛ}_{0} {r}_{1 / 2}} ) - 1 / 2 \times \frac{{q}^{2}}{4 π {ɛ}_{0} r} \\ = \frac{{q}^{2}}{8 π {ɛ}_{0} r} ( 1 - {2}^{- 2 / 3} )\end{matrix} \qquad ( Equation 4 )$$

The bubble is metastable if the overall energy change is negative which occurs when ΔE_{ST}+ΔE_{q} is negative, thereby providing:

$$\frac{{q}^{2}}{8 π {ɛ}_{0} r} ( 1 - {2}^{- 2 / 3} ) + 4 πγ {r}^{2} ( {2}^{1 / 3} - 1 ) \leq 0 \qquad ( Equation 5 )$$

which provides the relationship between the radius and the charge density (Φ):

$$Φ = \frac{q}{4 π {r}^{2}} \geq \sqrt{\frac{2 γ {ɛ}_{0}}{r} \frac{( {2}^{1 / 3} - 1 )}{( 1 - {2}^{- 2 / 3} )}} \qquad ( Equation 6 )$$

Accordingly, for nanobubble diameters of 5 nanometers, 10 nanometers, 20 nanometers, 50 nanometers, and 100 nanometers the calculated charge density for bubble splitting 0.12, 0.08, 0.06, 0.04 and 0.03 e⁻/nanometer² bubble surface area, respectively. For the same surface charge density, the bubble diameter is typically about three times larger for reducing the apparent surface tension to zero than for splitting the bubble in two. Thus, the nanobubbles will generally not divide unless there is a further energy input.

The EA liquid, containing the gas-phase bubbles (e.g., macrobubbles, microbubbles, and nanobubbles), exits electrolysis cell 52 via fluid outlets 66a and 66b, and the sub-streams may re-converge at fluid conduit 30. Although the anolyte and catholyte fuels are blended prior to being dispensed from spray bottle 10, they are initially not in equilibrium and temporarily retain their electrochemically-activated states. Accordingly, the EA liquid contains gas-phase bubbles dispersed/suspended in the liquid-phase.

The above-discussed gas-phase nanobubbles are adapted to attach to particles of the cosmetic substances, thereby transferring their ionic charges. The nanobubbles stick to hydrophobic surfaces, which are typically found on typical water-resistant cosmetic substances (e.g., water-resistant waxes), which releases water molecules from the high energy water/hydrophobic surface interface with a favorable negative free energy change. Additionally, the nanobubbles spread out and flatten on contact with the hydrophobic surface, thereby reducing the curvatures of the nanobubbles with consequential lowering of the internal pressure caused by the surface tension. This provides additional favorable free energy release. The charged and coated cosmetic substance particles are then more easily separated one from another due to repulsion between similar charges, and cosmetic substance dirt particles may enter the solution as colloidal particles.

Furthermore, the presence of nanobubbles on the surface of particles increases the pickup of the particle by micron-sized gas-phase bubbles, which may also be generated during the electrochemical activation process. The presence of surface nanobubbles also reduces the size of the cosmetic substance particle that can be picked up by this action. Such pickup assist in the removal of the cosmetic substance from surface 14. Moreover, due to the large gas/liquid surface area-to-volume ratios that are attained with gas-phase nanobubbles, water molecules located at this interface are held by fewer hydrogen bonds, as recognized by water's high surface tension. Due to this reduction in hydrogen bonding to other water molecules, this interface water is more reactive than normal water and will hydrogen bond to other molecules more rapidly, thereby showing faster hydration.

For example, at 100% efficiency a current of one ampere is sufficient to produce 0.5/96,485.3 moles of hydrogen (H2) per second, which equates to 5.18 micromoles of hydrogen per second, which correspondingly equates to 5.18×22.429 microliters of gas-phase hydrogen per second at a temperature of 0° C. and a pressure of one atmosphere. This also equates to 125 microliters of gas-phase hydrogen per second at a temperature of 20° C. and a pressure of one atmosphere. As the partial pressure of hydrogen in the atmosphere is effectively zero, the equilibrium solubility of hydrogen in the electrolyzed solution is also effectively zero and the hydrogen is held in gas cavities (e.g., macrobubbles, microbubbles, and/or nanobubbles).

Assuming the flow rate of the electrolyzed solution is 0.12 U.S. gallons per minute, there is 7.571 milliliters of water flowing through the electrolysis cell each second. Therefore, there are 0.125/7.571 liters of gas-phase hydrogen within the bubbles contained in each liter of electrolyzed solution at a temperature of 20° C. and a pressure of one atmosphere. This equates to 0.0165 liters of gas-phase hydrogen per liter of solution less any of gas-phase hydrogen that escapes from the liquid surface and any that dissolves to supersaturate the solution.

The volume of a 10 nanometer-diameter nanobubble is 5.24×10−22 liters, which, on binding to a hydrophobic surface covers about 1.25×10−16 square meters. Thus, in each liter of solution there would be a maximum of about 3×10−19 bubbles (at 20° C. and one atmosphere) with combined surface covering potential of about 4000 square meters. Assuming a surface layer just one molecule thick, this provides a concentration of active surface water molecules of over 50 millimoles. While this concentration represents a maximum amount, even if the nanobubbles have greater volume and greater internal pressure, the potential for surface covering remains large. Furthermore, only a small percentage of the cosmetic substance particles surfaces need to be covered by the nanobubbles for the nanobubbles to have a removal effect.

Accordingly, the gas-phase nanobubbles, generated during the electrochemical activation process, are beneficial for attaching to cosmetic substance particles so transferring their charge. The resulting charged and coated particles are more readily separated one from another due to the repulsion between their similar charges. They will enter the solution to form a colloidal suspension. Furthermore, the charges at the gas/water interfaces oppose the surface tension, thereby reducing its effect and the consequent contact angles. Also, the nanobubbles coating of the cosmetic substance particles promotes the pickup of larger buoyant gas-phase macrobubbles and microbubbles that are introduced. In addition, the large surface area of the nanobubbles provides significant amounts of higher reactive water, which is capable of the more rapid hydration of suitable molecules.

FIG. 3 is a schematic illustration of electrolysis cell 68, which is an example of an alternative electrolysis cell to cell 52 (shown in FIG. 2) for electrochemically activating the liquid, without the use of an ion exchange membrane. As shown in FIG. 3, electrolysis cell 68 may engage directly with fluid lines 70 and 72, where fluid line 70 receives the liquid from filter 24 and fluid line 72 allows the EA fluid to flow to fluid conduit 30. Electrolysis cell 68 includes reaction chamber 74, anode electrode 76, and cathode electrode 78. Reaction chamber 74 can be defined by the walls of electrolysis cell 68, by the walls of a container or conduit in which anode electrode 76 and cathode electrode 78 are placed, or by anode electrode 76 and cathode electrode 78 themselves. Suitable materials and constructions for anode electrode 76 and cathode electrode 78 include those discussed above for anode electrode 60 and cathode electrode 62 (shown in FIG. 2).

During operation, the liquid is introduced into reaction chamber 74 via fluid line 70, and a voltage potential is applied across anode electrode 76 and cathode electrode 78. This electrochemically activates the liquid, where portions of the liquid near or in contact with anode electrode 76 and cathode electrode 78 generate gas-phase bubbles in the same manner as discussed above for electrolysis cell 52. Thus, the liquid flowing through electrolysis cell 68 contains gas-phase bubbles dispersed or otherwise suspended in the liquid-phase. In comparison to electrolysis cell 52, however, the EA liquid is blended during the entire electrolysis process, rather than being split upstream from, or within, the electrolysis cell, and then re-converged, or within, downstream from the electrolysis cell. Accordingly, the resulting EA liquid contains gas-phase bubbles dispersed/suspended in the liquid-phase.

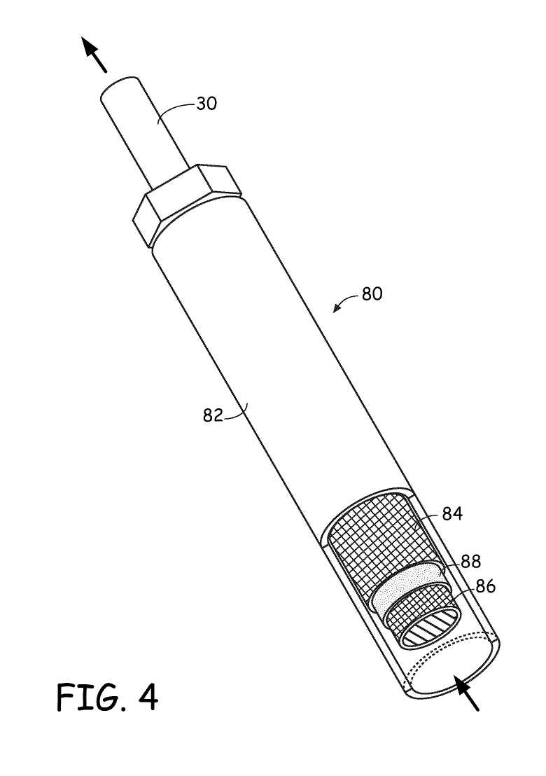

The anode and cathode electrodes themselves can have any suitable shape, such as planar, coaxial plates, cylindrical rods, or a combination thereof. FIG. 4 illustrates an example of an electrolysis cell 80 having a tubular shape. Portions of cell 80 are cut away for illustration purposes. In this example, cell 80 is an electrolysis cell having a tubular housing 82, tubular outer electrode 84, and tubular inner electrode 86, which is separated from the outer electrode by a suitable gap, such as 0.020 inches. Other gap sizes can also be used. An ion-selective membrane 88 is positioned between the outer and inner electrodes 84 and 86. Suitable materials and constructions for outer electrode 84 and inner electrode 86 include those discussed above for anode electrode 60 and cathode electrode 62 (shown in FIG. 2). Furthermore, suitable materials for membrane 88 include those discussed above for membrane 54 (shown in FIG. 2).

In this example, the volume of space within the interior of inner electrode 86 is blocked to promote liquid flow along and between electrodes 84 and 86 and membrane 88. This liquid flow is conductive and completes an electrical circuit between the two electrodes. Electrolysis cell 80 can have any suitable dimensions. In one example, cell 80 can have a length of about 4 inches long and an outer diameter of about ¾ inch. The length and diameter can be selected to control the treatment time and the quantity of bubbles (e.g., nanobubbles and/or microbubbles) generated per unit volume of the liquid.

Cell 80 can include a suitable fitting at one or both ends of the cell. Any method of attachment can be used, such as through plastic quick-connect fittings. For example, one fitting can be configured to connect to fluid conduit 30 (shown in FIG. 1). Another fitting can be configured to connect to the inlet filter 24 or an inlet tube. In another example, one end of cell 80 is left open to draw liquid directly from reservoir 22 (shown in FIG. 1). Examples of suitable designs for electrolysis cell 80 include those disclosed in U.S. patent application Ser. No. 12/488,360, entitled “Tubular Electrolysis Cell And Corresponding Method”.

In the example shown in FIG. 4, cell 80 produces anolyte EA liquid in the anode chamber (between one of the electrodes 84 or 86 and membrane 88) and catholyte EA liquid in the cathode chamber (between the other of the electrodes 84 or 86 and membrane 88). The anolyte and catholyte EA liquid flow paths join at the outlet of cell 80 as the anolyte and catholyte EA liquids enter fluid conduit 30 (in the example shown in FIG. 1). As a result, spray bottle 10 dispenses a blended anolyte and catholyte EA liquid through nozzle 36.

In one example, the diameters of fluid conduits 30 and 32 have small inner diameters such that, once electrolysis cell 26 (e.g., cell 80 shown in FIG. 4) and pump 34 are energized, fluid conduits 30 and 32 are quickly primed with the EA liquid. Any non-activated liquid contained in the tubes and pump are kept to a small volume. Thus, in the embodiment in which the control electronics 42 activate electrolysis cell 26 and pump 34 in response to actuation of switch 38, spray bottle 10 produces the blended EA liquid at nozzle 36 in an “on demand” fashion and dispenses substantially all of the combined anolyte and catholyte EA liquid (except that retained in fluid conduits 30 and 32, and pump 34) without an intermediate step of storing the anolyte and catholyte EA liquids. When switch 40 is not actuated, pump 34 is in an “off” state and electrolysis cell 26 is de-energized. When switch 40 is actuated to a closed state, control electronics 42 switches pump 34 to an “on” state and energizes electrolysis cell 26. In the “on” state, pump 34 pumps water from reservoir 22 through electrolysis cell 26, and out nozzle 36 as stream 12. Other activation sequences can also be used. For example, control circuit 42 can be configured to energize electrolysis cell 26 for a period of time before energizing pump 34 in order to allow the liquid to become more electrochemically activated before dispensing.

The travel time from electrolysis cell 26 to nozzle 36 can be made very short. In one example, spray bottle 10 dispenses the blended anolyte and catholyte liquid within a very small period of time from which the anolyte and catholyte liquids are produced by electrolysis cell 26. For example, the blended EA liquid can be dispensed within time periods such as within 5 seconds, within 3 seconds, and within 1 second of the time at which the anolyte and catholyte liquids are produced.

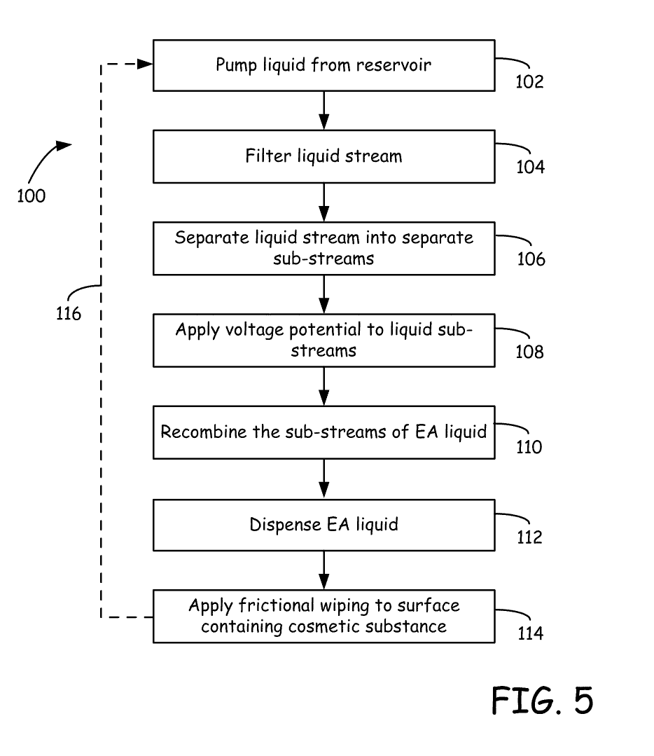

FIG. 5 is a flow diagram of method 100 for removing one or more cosmetic substances with the use of an EA liquid. The EA liquid is suitable for assisting in the removal of a variety of different cosmetic substances. Examples of suitable cosmetic substances that may be removed include mascaras, eyeliners, eye shadows, foundation creams, face powders, rouge, lipsticks, and combinations thereof. Suitable mascara-based cosmetic substances that may be removed with the use of the EA liquid include non-water-resistant mascaras and water-resistant mascaras. Examples of suitable non-water-resistant mascaras include soft surfactants (e.g., triethanolamine stearates), waxes (e.g., beeswaxes, carnauba waxes, rice bran waxes, candelilla waxes, and paraffin waxes), and combinations thereof.

Because non-water-resistant mascaras may be removed with standard water, the EA liquids and method of use, as discussed above, are particularly suitable for assisting in the removal of water-resistant mascaras, which are typically difficult to remove with standard water. As discussed above, the gas-phase nanobubbles, generated during the electrochemical activation process, are beneficial for attaching to particles of the cosmetic substance so transferring their charge. The resulting charged and coated particles are more readily separated one from another due to the repulsion between their similar charges, and they will enter the solution to form a colloidal suspension. This allows the EA liquid to remove materials that are otherwise resistant to water (e.g., water-resistant waxes). Also, the nanobubbles coating of the cosmetic substance particles promotes the pickup of larger buoyant gas-phase macrobubbles and microbubbles that are introduced. Furthermore, the large surface area of the nanobubbles provides significant amounts of higher reactive water, which is capable of the more rapid hydration of suitable molecules.

Examples of suitable water-resistant mascaras include waxes (e.g., beeswaxes, carnauba waxes, rice bran waxes, candelilla waxes, and paraffin waxes) that are substantially free of water-sensitive moieties, latex-based materials, and combinations thereof. Suitable compositions for the waxes include lipids of long-chain alkanes, esters, polyesters, hydroxyl-esters of long-chain primary alcohols and fatty acids, and combinations thereof. Examples of suitable eyeliner-based and eye shadow-based cosmetic substances that may be removed with the use of the EA liquid include powder-based materials (e.g, powder and mica blends), wax-based materials, gel-based materials, and combinations thereof.

The following discussion of method 100 is made with reference to spray bottle 10 (shown in FIG. 1) with the understanding that method 100 is suitable for use with a variety of different dispensing devices (e.g., spray bottle 10) and surfaces (e.g., surface 14). Method 100 includes steps 102-114, and initially involves pumping the liquid from reservoir 22 (step 102) and through filter 24 to remove any potential impurities in the liquid (step 104). The liquid may then be split into multiple sub-streams to enter the anode and cathode chambers of one or more electrolysis cells (step 106). As discussed above, this may be performed prior to the liquid stream entering the electrolysis cell(s), or may be performed within the electrolysis cell(s). As further discussed above, in alternative embodiments in which the one or more electrolysis cells do not incorporate ion-exchange membranes, steps 106 and 110 of method 100 may be omitted. While the liquid sub-streams flow through the electrolysis cell, a voltage potential is applied across anode and cathode electrodes and to the sub-streams (step 108). This generates gas-phase bubbles in the liquid-phase, where the gas-phase bubbles maintain their integrities due to their small diameters and ionic charges, as discussed above.

The resulting EA liquid sub-streams may then be recombined prior to being dispensed (step 110). For example, the sub-streams may be recombined after exiting the electrolytic cell as discussed above for electrolytic cell 52 (shown in FIG. 2), or prior to exiting the electrolytic cell (e.g., for tubular electrolytic cell 80). In alternative embodiments, the separation between the EA liquid streams maybe maintained until dispensed (e.g., with multiple nozzles). The combined EA liquid streams may then be dispensed onto a surface containing a cosmetic substance (e.g., surface 14) (step 112). The user may then apply frictional wiping to the surface containing the cosmetic substance (step 114). In alternative embodiments, the user may dispense the EA liquid onto a separate wipe, and then use the wipe containing the dispensed EA liquid to remove the cosmetic substance from the surface. Steps 102-114 may be repeated multiple times (represented by arrow 116) to ensure full removal of the cosmetic substances.

As discussed above, the use of the EA liquid allows cosmetic substances, including water-resistant substances, to be removed from a surface (e.g., epidermal skin) without requiring excessive frictional force. Moreover, the EA liquid is desirably non-irritating when contacting the eyes, mouth, and nasal passage of a user, particularly with aqueous-based EA liquids. This allows cosmetic substances to be readily removed from epidermal skin regions of a user with a reduced risk causing irritations to such regions.

Although the present disclosure has been described with reference to preferred embodiments, workers skilled in the art will recognize that changes may be made in form and detail without departing from the spirit and scope of the disclosure.

1. A method for removing a cosmetic substance, the method comprising:
electrochemically activating a liquid;
dispensing the electrochemically-activated liquid to a surface containing the cosmetic substance; and
applying frictional wiping to the surface containing the cosmetic substance and the applied electrochemically-activated liquid.

2. The method of claim 2, and further comprising:
introducing the liquid into an electrolysis cell, the electrolysis cell having at least one cathode electrode and at least one anode electrode; and
applying a voltage potential across the at least one cathode electrode and the at least one anode electrode to generate the electrochemically-activated liquid from the liquid.

3. The method of claim 2, and further comprising maintaining separation of at least two portions of the liquid with at least one ion exchange membrane disposed between the at least one cathode electrode and the at least one anode electrode.

4. The method of claim 1, wherein electrochemically activating the liquid comprises generating gas-phase bubbles in the liquid.

5. The method of claim 1, wherein dispensing the electrochemically-activated liquid comprises spraying the electrochemically-activated liquid.

6. The method of claim 1, wherein the cosmetic substance is selected from the group consisting of soft surfactants, waxes, latex-based materials, powder-based materials, gel-based materials,and combinations thereof.

7. The method of claim 1, wherein the cosmetic substance comprises a wax that is substantially free of water-sensitive moieties.

8. A method for removing a cosmetic substance, the method comprising:
directing a liquid through an electrolysis cell carried by a dispenser to produce an anolyte liquid and a catholyte liquid in the electrolysis cell;
combining a flow of the anolyte liquid with a flow of the catholyte liquid to form a blended anolyte and catholyte liquid;
dispensing the blended anolyte and catholyte liquid from the dispenser; and
applying frictional wiping to a surface containing the cosmetic substance using the electrochemically-activated liquid.

9. The method of claim 8, wherein the blended anolyte and catholyte liquid are dispensed onto the surface containing the cosmetic substance.

10. The method of claim 8, wherein the blended anolyte and catholyte liquid are dispensed onto an intermediary surface, and wherein the intermediary surface containing the dispensed blended anolyte and catholyte liquid is used to apply the frictional wiping to the surface containing the cosmetic substance.

11. The method of claim 8, wherein dispensing the blended anolyte and catholyte liquid comprises spraying the blended anolyte and catholyte liquid.

12. The method of claim 8, and further comprising maintaining separation of at least two portions of the liquid with at least one ion exchange membrane.

13. The method of claim 8, wherein the cosmetic substance is selected from the group consisting of soft surfactants, waxes, latex-based materials, powder-based materials, gel-based materials,and combinations thereof.

14. The method of claim 8, wherein the cosmetic substance comprises a wax that is substantially free of water-sensitive moieties.

15. A method for removing a cosmetic substance, the method comprising:
introducing a first part of a liquid into a first electrolysis chamber comprising a first electrode;
introducing a second part of the liquid into a second electrolysis chamber comprising a second electrode, wherein the second electrolysis chamber is separated from the first electrolysis chamber by an ion exchange membrane;
applying a voltage across the first and second electrodes to electrochemically activate the first and second parts of the liquid;
dispensing the electrochemically-activated first and second parts of the liquid as a blended output spray from the spray bottle; and
applying frictional wiping to a surface containing the cosmetic substance with the use of the dispensed electrochemically-activated, blended output spray.

16. The method of claim 15, wherein the electrochemically-activated, blended output spray is dispensed onto the surface containing the cosmetic substance.

17. The method of claim 15, wherein the electrochemically-activated, blended output spray is dispensed onto an intermediary surface, and wherein the intermediary surface containing the dispensed electrochemically-activated, blended output spray is used to apply the frictional wiping to the surface containing the cosmetic substance.

18. The method of claim 15, wherein electrochemically activating the first and second parts of the liquid comprises generating gas-phase bubbles in the first and second parts of the liquid.

19. The method of claim 15, wherein the cosmetic substance is selected from the group consisting of soft surfactants, waxes, latex-based materials, powder-based materials, gel-based materials,and combinations thereof.

20. The method of claim 15, wherein the cosmetic substance comprises a wax that is substantially free of water-sensitive moieties.
